(19) United States
(12) Patent Application Publication
(10) Pub. No.: US 2008/0143175 A1
(43) Pub. Date: Jun. 19, 2008

(54) Beam axle system

(76) Inventors: Richard Chambers, Mattawan, MI (US); Fernando Ledesma, Jose Hernandez (AR); James F. Ziech, Kalamazoo, MI (US)

Correspondence Address: MARSHALL & MELHORN, LLC, FOUR SEAGATE - EIGHTH FLOOR, TOLEDO, OH, 43604, US

(21) Appl. No.: 11/638,728

(22) Filed: Dec. 14, 2006

(51) Int. Cl. B60B 35/08; B23P 11/00

(52) U.S. Cl. 301/132; 29/428

(57) ABSTRACT

An axle system and method of assembling the same includes a center tube and two cast ends for receiving the center tube within a cavity of each cast end. Suspension mounting portions are integrally formed with the cast ends.

### FIELD OF THE INVENTION

The present invention relates to a beam axle system for a vehicle. More particularly, the invention may relate to a front steer beam axle system for a vehicle.

### BACKGROUND OF THE INVENTION

It is well known that structures are typically attached to the ends of an axle to support a wheel end assembly on each end. Such structures may at least include a knuckle and its associated spindle which are supported for pivotal motion on the axle with a king pin.

For example, in U.S. Pat. No. 2,432,708, a collar extends about an end of an axle and is secured thereto by a weld line. A cap is located over the end of the axle to close it off as the collar does not cover the open end of the axle. An arm member extends from the collar to a king pin support. A yoke arm rotationally is attached to the knuckle with a king pin.

A saddle member, used to connect a suspension member to the axle, is located on the axle inboard and separate from the connection of the collar to the axle. Thus, a separate step must be made to attach the saddle member to the axle. Further, since the saddle member is separately attached to the axle, it is weaker than a suspension component mounting that is integrally formed with either the axle, the collar, the arm member, etc.

Published U.S. Patent Application No. 2004/0145144 and related European Patent Application No. 04250426.6 both teach another means of providing a structure to support a wheel end assembly on an axle. In these applications, end sections are attached to a center section of a front axle beam by engaging interlocking features on each end section with the center section and then bolting the end sections to the center section. It can be appreciated that the joints between the end sections and the center section become highly loaded when the end sections are subject to braking and wheel end forces.

### SUMMARY OF THE INVENTION

An axle system having a center tube and two one-piece integrally formed cast ends secured to the center tube is described. The center tube has a longitudinal axis and a first end portion and a second end portion aligned with the axis.

The cast ends each have an outboard portion and an inboard portion. The outboard portions each define an integrally formed king pin support. The inboard portions each define a cavity aligned with the longitudinal axis. The cavities have a substantially complimentary shape of the center tube so that they at least partially radially enclose the outer surface of the center tube therein.

### BRIEF DESCRIPTION OF THE DRAWINGS

The above, as well as other advantages, will become readily apparent to those skilled in the art from the following detailed description when considered in the light of the accompanying drawings in which:

FIG. 1 is a schematic, exploded perspective view of one embodiment of a center tube and cast ends;

FIG. 2 is a schematic, perspective view of another embodiment of the center tube and cast ends;

FIG. 3 is a schematic, perspective view of another embodiment of the center tube and cast ends; and

FIG. 4 is a schematic, cutaway side view of one embodiment of a cast end.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

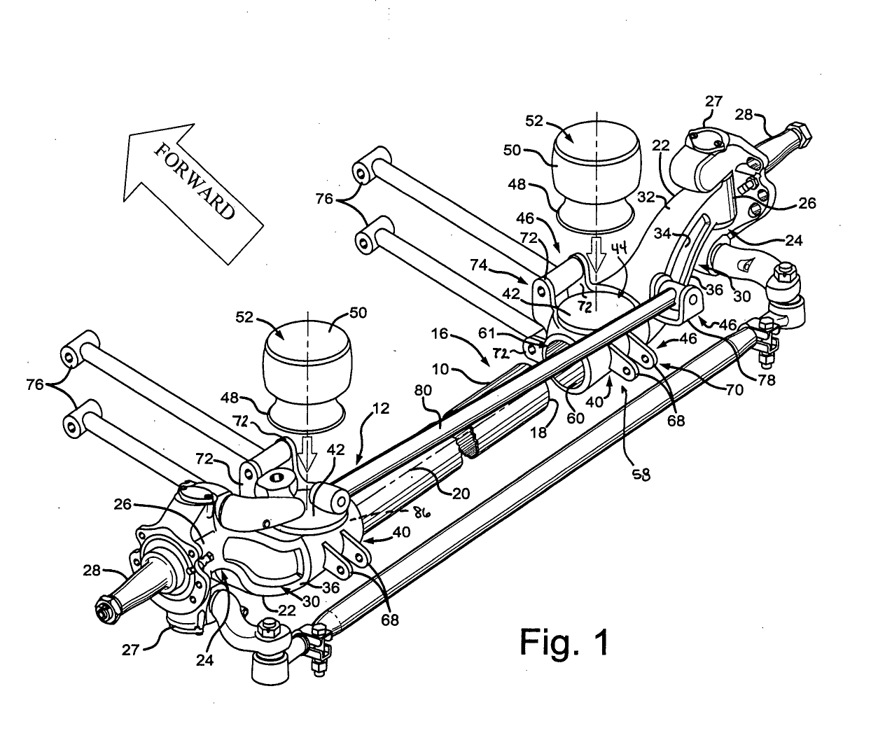

Referring now to FIG. 1, one embodiment of a one-piece center tube 10 is depicted. The center tube 10 has a first end portion 12, a first end edge 14, a second end portion 16 and a second end edge 18.

While the center tube 10 is depicted in all the figures herein as having a round cross section, center tubes 10 having any cross section, including oval or any polygon shape or an I-beam shape may be used despite the use of the term “tube” herein. Further, while a tube structure is preferred, a traditional tube is not required. Instead, a solid, or even a partially solid, structure may comprise the center tube 10 as used herein.

Additionally, center tubes 10 having any length are within the scope of the present invention. Thus, since the length of the center tube 10 is not a limiting factor, it can be appreciated that center tubes 10 of different lengths can be used to fit different vehicles.

Regardless of the length or shape of the center tube 10, it is preferred that the center tube 10 has a longitudinal axis 20 along which a cavity, described in more detail below, of each end portion, which is also described in more detail below, is aligned.

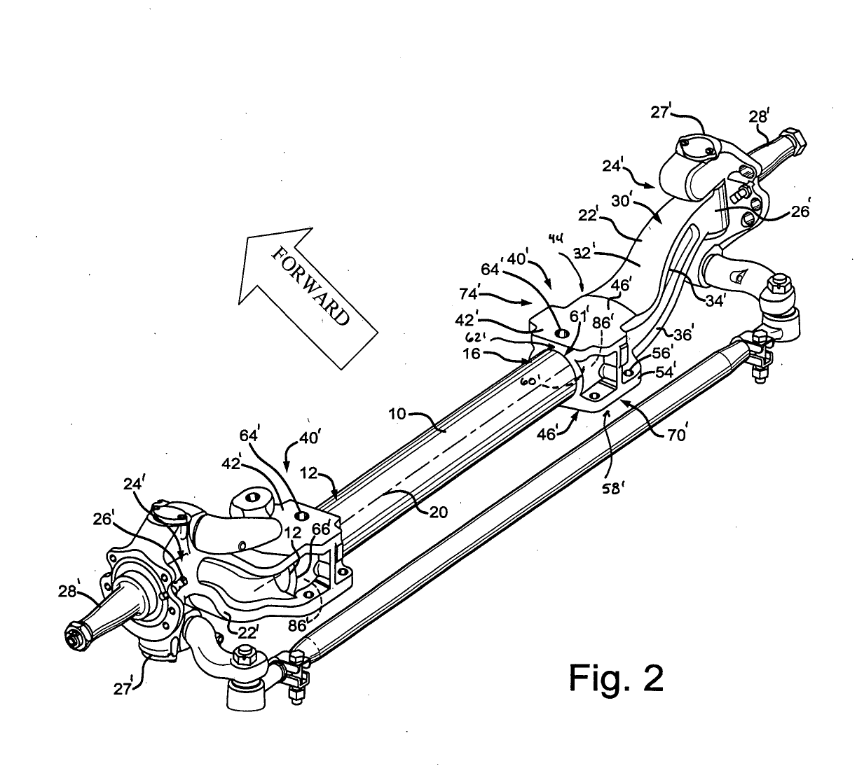

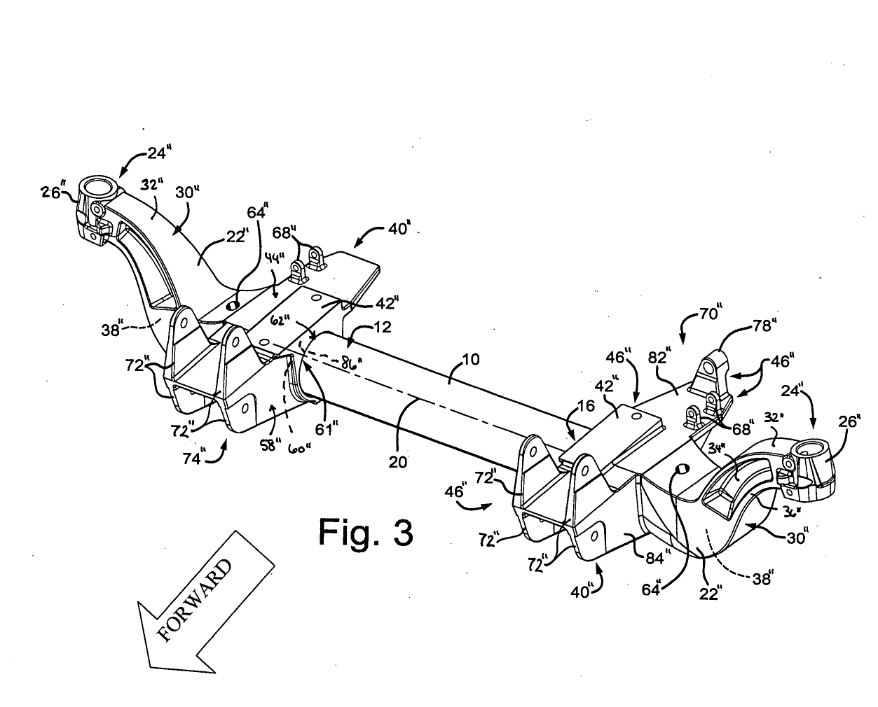

FIG. 1 also depicts one embodiment of two one-piece integrally formed cast ends 22. Other embodiments, however, of the cast ends 22 are permissible. Other exemplary embodiments of the cast ends from those depicted in FIG. 1 are described and depicted herein. Features that are similar to those depicted in the first embodiment, which is shown by way of example in FIG. 1, in FIGS. 2 and 3 are provided with reference numbers having a prime and double prime, respectively.

Each cast end 22, 22′, 22″ has an outboard portion 24, 24′, 24″ that defines a king pin support 26, 26′, 26″. The king pin support 26, 26′, 26″ is a substantially vertically oriented tube for receiving a king pin (not shown). Each king pin rotationally supports a knuckle 27, 27′ (not shown in the third embodiment corresponding to FIG. 3) with a spindle 28, 28′ (not shown in FIG. 3) and permits the spindle 28, 28′ to pivot with respect to the cast end 22, 22′, 22″.

While one embodiment of a knuckle 27, 27′ and a spindle 28, 28′ is depicted, it must be appreciated that the cast ends 22, 22′, 22″ can be formed to have mounted thereon knuckles 27, 27′ and spindles 28, 28′ of any size and/or shape without departing from the scope of the present invention.

Each outboard portion 24, 24′, 24″ is connected to an intermediate portion 30, 30′, 30″ of each cast end 22, 22′, 22″. The intermediate portion 30, 30′, 30″ may be an I-beam configuration with an upper flange 32, 32′, 32″, a central web 34, 34′, 34″ and a lower flange 36, 36′, 36″.

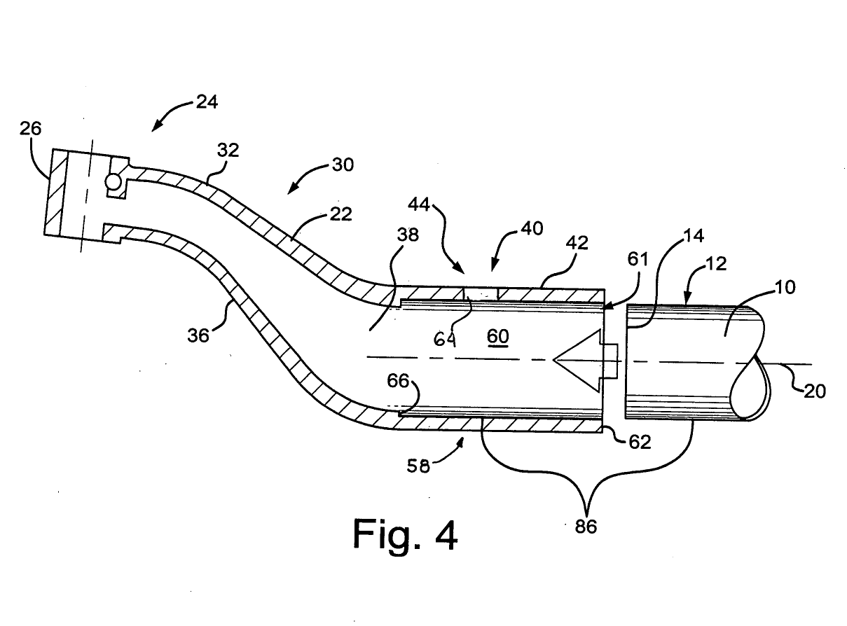

The intermediate portion 30, 30′, 30″ may be solid or hollow. For example, FIG. 4 depicts an embodiment of FIG. 1 wherein the intermediate portion 30 has a hollow interior 38. The hollow interior 38 may comprise substantially all of the intermediate portion 30, as shown in FIG. 1, or only part of the intermediate portion 30. The outboard portion 24 of the cast end 22 of FIG. 4 is also hollow.

The intermediate portion 30, 30′, 30″ is connected to an inboard portion 40, 40′, 40″ of the cast end 22, 22′, 22″. The vertical drop between the outboard portion 24, 24′, 24″ and the inboard portion 40, 40′, 40″ via the intermediate portion 30, 30′, 30″ is not limited to the embodiments depicted in the figures. Instead, the vertical drop between the outboard portion 24, 24′, 24″ and the inboard portion 40, 40′, 40″ can be any distance and at any angle without departing from the scope of the invention.

By varying the vertical drop between the outboard portion 24, 24′, 24″ and the inboard portion 40, 40′, 40″, it can be appreciated that the cast ends 22, 22′, 22″ and center tube 10 can be tailored to fit a variety of different vehicles that require different distances from the inboard portion 40, 40′, 40″ to the outboard portion 24, 24′, 24″.

In one embodiment, the inboard portion 40, 40′, 40″ defines a spring seat 42, 42′, 42″ on an upper portion 44, 44′, 44″ thereof. The spring seat 42, 42′, 42″ is part of a group of suspension mounting portions 46, 46′, 46″ of the cast end 22, 22′, 22″. The other suspension mounting portions 46, 46′, 46″ may be one or more shock absorber brackets, one or more track rod brackets, one or more U-bolt flanges, and/or one or more suspension control rod brackets each of which is discussed below.

While the suspension mounting portions 46, 46′, 46″ are shown in specific locations on the cast ends 22, 22′, 22″ in the figures, they may be located on the inboard portions 40, 40′, 40″ of the cast ends 22, 22′, 22″ other than as depicted. For example, as described below the shock absorber brackets 68, 68″ (not shown in FIG. 2) are depicted on a rear side 70, 70′, 70″ of the cast ends 22, 22′, 22″. The brackets 68, 68″, however, may be located on a forward side 74, 74′, 74″ of the cast ends 22, 22′, 22″. Similarly, any of the other suspension mounting portions 46, 46′, 46″ may be located on the opposite side of the cast ends 22, 22′, 22″ than as shown.

The spring seat 42, 42′, 42″ is substantially planar and it may be flat, as shown in FIGS. 1 and 2, or it may be angled, as shown in FIG. 3. The spring seat 42 of FIG. 1 is adapted to receive the base 48, or piston, of an air spring 50 thereon. The upper portion 52 of the air spring 50 is attached to the vehicle frame (not shown) as known by those skilled in the art. The spring seat 42″ depicted in FIG. 3 is angled to receive the base, or piston, of an air spring thereon.

The spring seat 42′ depicted in FIG. 2 is flat to receive a leaf spring (not shown) thereon. The ends of the leaf spring are attached to the vehicle frame as known by those skilled in the art.

In FIG. 2, a flange 54′ containing apertures 56′ to receive the U-bolts (not shown) that typically capture the leaf spring can be integrally formed with the inboard portion 40′ of each cast end 22′. The flange 54′ can extend both forwardly and rearwardly from the inboard portion 40′. The U-bolts can extend over the leaf spring and then extend through the apertures 56′. Nuts and washers can be located on the ends of the U-bolts to secure them, as well as the captured leaf spring, to the spring seat 42′.

An upper portion 44, 44′, 44″ and a lower portion 58, 58′, 58″ of each cast end 22, 22′, 22″ may define a cavity 60, 60′, 60″ therebetween. The cavity 60, 60′, 60″ has a complementary shape to the exterior of the center tube 10, regardless of its shape or size. An entranceway 61, 61′, 61″ for each cavity 60, 60′, 60″ is defined in an inboard edge 62, 62′, 62″ of each cast end 22, 22′, 22″.

The center tube 10 can be inserted at least partially into the cavity 60, 60′, 60″. As shown in FIGS. 2, 3 and 4, at least one aperture 64, 64′, 64″ may be provided in each inboard portion 40, 40′, 40″. The apertures 64, 64′, 64″ may be used for puddle welds to secure the cast ends 22, 22′, 22″ to the center tube 10. While the apertures 64, 64′, 64″ are depicted in the figures as being located on the upper portions 44, 44′, 44″ of the cast ends 22, 22′, 22″, the apertures 64, 64′, 64″ may be located in other locations on the cast ends 22, 22′, 22″. For example, the apertures 64, 64′, 64″ may be located on the upper portions 44, 44′, 44″, the lower portions 58, 58′, 58″, the rear side 70, 70′, 70″ and/or the forward side 74, 74′, 74″ of the cast ends 22, 22′, 22″.

Although a weld aperture is not shown in FIG. 1, it is permissible for this embodiment to have this feature as well. Furthermore, while the cast ends 22, 22′, 22″ may be secured to the center tube 10 via welding, the cast ends 22, 22′, 22″ may be attached with an adhesive and/or press fit into the tube 10.

Each cavity 60, 60′, 60″ may have a shoulder 66, as shown in FIG. 4. The shoulder 66 has a complementary shape to the first end edge 14 and the second end edge 18 of the center tube 10.

Looking now at FIGS. 1 and 3, shock absorber brackets 68, 68″ may be integrally formed with the inboard portion 40, 40″ of each cast end 22, 22″. One end of a shock absorber (not shown) may be attached to the shock absorber bracket 68, 68″ and the other end is attached to the vehicle frame, as known by those skilled in the art. A shock absorber bracket 68, 68″ may be located on a forward side 74, 74″ or a rear side 70, 70″ of each inboard portion 40, 40″ of each cast end 22, 22″. As can be appreciated from FIGS. 1 and 3, shock absorber brackets 68, 68″ of different shapes, sizes and locations on the inboard portions 40, 40″ of the cast ends 22, 22″ are permissible.

At least one control rod bracket 72, 72″ may be integrally formed with a forward side 74, 74″ of the inboard portion 40, 40″ of each cast end 22, 22″. As shown in FIGS. 1 and 3, two control rod brackets 72, 72″ are integrally formed with the forward side 74, 74″ of the inboard portion 40, 40″ of each cast end 22, 22″. The two control rod brackets 72, 72″ permit two parallelogram suspension control rods 76 (not shown in FIG. 3) to be pivotally attached to the cast end 22, 22″. The control rods 76 are attached at their opposite ends to the frame of the vehicle as known by those skilled in the art. Control rod brackets 72, 72″ of differing size, shape and location on the inboard portion 40, 40″ of each cast end 22, 22″ can be appreciated based on the embodiments depicted in FIGS. 1 and 3.

As also seen in FIGS. 1 and 3, a track rod bracket 78, 78″ may be integrally formed with the inboard portion 40, 40″ of one of the cast ends 22, 22″. The track rod bracket 78, 78″ permits the pivotal attachment of one end of a track rod 80 (not shown in FIG. 3). The other end of the track rod 80 is attached to the vehicle frame as known by those skilled in the art. The track rod bracket 78, 78″ may have any size, shape or location on the inboard portion 40, 40″, as shown in the examples of FIGS. 1 and 3.

In the depicted embodiments, the cavity 60, 60′, 60″ is preferably located beneath the spring seat 42, 42′, 42″, in front of the shock absorber bracket 68, 68″ and behind the suspension control rod bracket 72, 72″. While the location of the cavity 60, 60′, 60″ has been described with respect to the spring seat 42, 42′, 42″, the shock absorber bracket 68, 68″ and the control rod bracket 72, 72″, it should be appreciated that the cast end 22, 22′, 22′ need not have these suspension mounting portions 46, 46′, 46″.

FIG. 3 depicts another permissible embodiment of the inboard portions 40″ of the cast ends 22″. In FIG. 3, the inboard portion 40″ includes both a rearwardly extending portion 82″ and a forwardly extending portion 84″ to which the brackets, such as the shock absorber brackets 68″, track rod bracket 78″ and control rod brackets 72″ respectively, are integrally formed. It can be appreciated that it is permissible to have a rearwardly extending portion 82″, a forwardly extending portion 84″.

Preferably, the suspension mounting portions 46, 46′, 46″ are all located outboard of the entranceway 61, 61′, 61″ of the cavity 60, 60′, 60″ in each cast end 22, 22′, 22″. This results in the various suspension components, such as air bags, leaf springs, shock absorbers and/or suspension rods, if any, being connected to the cast ends 22, 22′, 22″ outboard of the entranceway 61, 61′, 61″.

A method of assembling the cast ends 22, 22′, 22″ to the center tube 10 comprises selecting a center tube 10 having a predetermined length. It can be appreciated that the length depends on the vehicle in which the center tube 10 will be used. By being able to utilize center tubes 10 of virtually any length, the center tube 10 can be adapted to fit almost any vehicle.

Similarly, any cast ends 22, 22′, 22″ adaptable to the center tube 10 selected and the wheel end components may be used. Thus, cast ends 22, 22′, 22″ of various sizes and shapes may be used to fit almost any vehicle.

The cast ends 22, 22′, 22″ are preferably press fit onto the first and second end portions 12, 16 of the center tube 10. Specifically, the center tube 10 is forcibly inserted into the cavities 60, 60′, 60″ of the cast ends 22, 22′, 22″. The center tube 10 is inserted until the first end edge 14 and the second end edge 18 contact the shoulders 66 within the cavities 60, 60′, 60″ thus forming the joints 86, 86′, 86″ described below.

The cast ends 22, 22′, 22″ can be welded, such as by puddle welds, to the center tube 10 via the apertures 64, 64′, 64″ in the cast ends 22′, 22″ extending to the tube 10, or via other welding techniques known by those skilled in the art. It is also within the scope of the present invention to utilize adhesive bonding to secure the cast ends 22, 22′, 22″ to the center tube 10 along the joints 86, 86′, 86″.

Being so connected, a joint 86, 86′, 86″ is formed between the first end portion 12 and one cast end 22, 22′, 22″ and the second end portion 16 and the other cast end 22, 22′, 22″. The joints 86, 86′, 86″ are aligned with the longitudinal axis 20 of the center tube 10.

The various suspension members can be connected to the suspension brackets of the cast ends 22, 22′, 22″. For example, a shock absorber may be pivotally attached to each shock absorber bracket 68, 68″, a track rod 80 (not shown in FIG. 3) can be pivotally attached to the track rod bracket 78, 78″, and/or control rods can be pivotally attached to each control rod bracket 72, 72″. An air spring 50, such as shown in FIG. 1, may be attached to the spring seat 42, 42′, 42″ on each cast end 22, 22′, 22″. Alternatively, a leaf spring may rest on the spring seat 42, 42′, 42″ and be connected to the cast end 22, 22′, 22″ as described above.

Those skilled in the art know that the tires of the vehicle, and thus the wheels connected to them, react to the changing surface of the ground. Those reactions are translated through the wheels to the spindles 28, 28′, the knuckles 27, 27′ and other associated wheel components. The knuckles 27, 27′, being connected to the king pin supports 26, 26′, 26″ of the cast ends 22, 22′, 22″, transfer the forces to the cast ends 22, 22′, 22″ as a result of the vehicle moving over the ground.

Similarly, when the vehicle is braked, the braked wheel transfers a force to it associated wheel components. This force is also transferred to the cast end 22, 22′, 22″ associated with the braked wheel. The brake system components, such as the pads, calipers, drums, rotors, etc., are part of the term wheel components as used herein.

The forces from the vehicle moving over the ground and/or from a wheel being braked are transferred to the cast end 22, 22′, 22″ associated with a braked or otherwise acted upon wheel. The forces are transferred through the one or more suspension mounting portions 46, 46′, 46″ formed with the cast ends 22, 22′, 22″ into the suspension members before the forces affect the joints 86, 86′, 86″.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A beam axle system, comprising:
a one-piece center tube having a longitudinal axis and a first end portion and a second end portion aligned along said longitudinal axis, each end portion having an outer surface; and
two one-piece integrally formed cast ends each comprising an outboard portion and an inboard portion, said outboard portions each defining an integrally formed king pin support, said inboard portions each defining a cavity aligned with said longitudinal axis, said cavity having a substantially complimentary shape of said center tube outer surface for at least partially radially enclosing said outer surface of said center tube therein, said inboard portions also having suspension mounting portions integrally formed therewith.

2. The system of claim 1, wherein said suspension mounting portions are located outboard from an entranceway of said cavity.

3. The system of claim 1, wherein said suspension mounting portions comprise one or more of spring seats, shock absorber brackets, track rod brackets and suspension control rod brackets.

4. The system of claim 1, wherein said inboard portions of said cast ends each have at least one access aperture for welding said cast ends to said center tube.

5. The system of claim 1, wherein said cast ends are substantially identically to one another.

6. A beam axle system, comprising:
a hollow center tube having a first end portion and a second end portion;
a first, one piece, integrally formed cast end having an inboard edge located inboard of a spring seat, a suspension control rod bracket and a shock absorber bracket of said first cast end; and
a second, one piece, integrally formed cast end, having an inboard edge located inboard of a spring seat, a suspension control rod bracket, a track rod bracket and a shock absorber bracket of said second cast end;
wherein said first cast end is attached to said first end portion of said center tube and said second cast end is attached to said second end portion of said center tube.

7. The system of claim 6, wherein said track rod bracket, said spring seats, said suspension control rod brackets and said shock absorber brackets are integrally formed with said cast ends.

8. The system of claim 6, wherein said cast ends each have an inboard portion comprising said inboard edge, said shock absorber bracket, said spring seat, said suspension control rod bracket and a cavity for receiving one of said end portions of said center tube.

9. The system of claim 8, wherein said cavity is beneath said spring seat, in front of said shock absorber bracket and behind said suspension control rod bracket.

10. The system of claim 8, wherein said first end portion, said second end portion, said cavity of said first cast end and said cavity of said second cast end are aligned with a longitudinal axis of said center tube.

11. The system of claim 6, wherein each of said cast ends has an outboard portion defining at king pin support, said outboard portion connected to said inboard portion via an intermediate portion.

12. The system of claim 11, wherein said intermediate portion is hollow.

13. The system of claim 11, wherein said intermediate portion has an I-beam configuration.

14. A method of assembling a front beam axle system, comprising:
providing a center tube having a first end portion and a second end portion, said end portions aligned along a longitudinal axis of said center tube;
locating said first end portion within a cavity of an inboard portion of a one-piece, integrally formed first cast end, said cavity being aligned with said longitudinal axis to form a first joint, said first cast end having said inboard portion, an intermediate portion and an outboard portion;
locating said second end portion within an inboard portion of a cavity of a one-piece, integrally formed second cast end to form a second joint aligned with said longitudinal axis, said second cast end having said inboard portion, an intermediate portion and an outboard portion, said outboard portions of said first end portion and said second end portion being connected to wheel components; and
connecting suspension components to suspension mounting portions of said inboard portions so that loads from said wheel components are substantially exclusively carried by said suspension components and bypass said joints.

15. The method of claim 14, wherein said outboard portions comprise king pin supports and loads from said wheel components are transferred to said king pin supports and said loads are transferred from said king pin supports to said suspension mounting portions of said inboard portions.

16. The method of claim 14, wherein said cast ends are coupled to center tubes of various lengths to change the width of said front beam axle system.

17. The method of claim 14, wherein pairs of cast ends having different vertical drops between said outboard portions and said inboard portions as compared to one another are attached to different center tubes to produce front beam axle systems of varying height.

18. The method of claim 14, wherein said cast ends are secured to said first end portion and said second end portion of said center tube by steps comprising press fitting, welding or adhesive bonding.

19. The method of claim 14, wherein said suspension components are connected to said suspension mounting portions which are one or more spring seats, shock absorber brackets, track rod brackets and suspension control rod brackets.
